(19) United States
(12) Patent Application Publication
(10) Pub. No.: US 2008/0100603 A1
(43) Pub. Date: May 1, 2008

(54) Driving method of liquid crystal display apparatus and driving circuit of the same

(75) Inventors: Satoru Matsuda, Shiga (JP); Takashi Morigami, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/976,160

(22) Filed: Oct. 22, 2007

(30) Foreign Application Priority Data
Nov. 1, 2006 (JP) 2006-297873

(51) Int. Cl. G09G 5/00

(52) U.S. Cl. 345/205

(57) ABSTRACT

An output circuit of a data driver in a liquid crystal display apparatus conducts a dot inversion driving method. The output circuit includes amplifiers that output the data signals on data lines, switches that separate the data lines from the amplifiers and short/precharge circuit that shorts the lines between the data lines, for a predetermined time, and then supply the same polarity precharge voltage as the polarity when writing the data signals on the data lines in a next sequence.

### BACKGROUND OF THE INVENTION

1. Field of the Invention

The present invention relates to the driving method of a liquid crystal display (LCD) apparatus and a driver performing the method and more particularly to the driving method of a LCD apparatus that employs a dot inversion driving method.

2. Description of Related Art

Liquid crystal display (LCD) apparatus as a dot matrix display apparatus is broadly used in various appliances such as a personal computer because its has an advantage of their thin-profile, light weight and low power consumption. In particular, the color LCD apparatus with active matrix method can display the image finely, and occupies the mainstream.

The color LCD apparatus includes a display panel, a scan driver and a data driver. The display panel is composed of a thin film transistor (TFT) liquid crystal panel. The panel has scan lines and data lines arranged in matrix. The scan driver drives the TFT gates through the scan lines. The data driver drives the TFT sources through the data lines. One pixel of the display panel is composed of 3 dots: R (red), G (green) and B (blue). In case that each dot of R, G and B is displayed in 256 grayscales, one pixel is displayed in 16777216 colors. When the image resolution is XGA (1024×768 pixels), the display panel allocates 1024×3=3072 dots in the horizontal direction and 768 dots in the vertical direction.

Such panels are driven by a dot inversion driving method. The method is a kind of a common constant driving method alternatively driving or reversely the display panel. The common constant driving method holds the electric potential of the common electrode (counter electrode) of a pixel and reverses the polarity of the data signal from the data driver. The dot inversion driving method writes the opposite polarity data signals on the two adjacent dots composed of the pixel. The polarity of the data signal is defined as positive polarity or negative polarity based on the predetermined reference electric potential (hereinafter, referred to as “common level”). Normally, the common level is set to ½ of the power supply voltage VDD2, which is applied to the data driver as a high voltage driving power supply.

A plurality of data driver integrated circuit (ICs) are used for driving a display panel. For example, if the image resolution of the display panel is XGA, 8 data driver Integrated circuits (ICs) are used. At this case, each of ICs handles 128 pixels.

The data driver outputs the positive and negative polarity data signals, as the voltage depending on the grayscale, as shown in FIG. 11. For example, in order to display black level by using the data signal of the positive polarity, the data driver outputs an electric potential V1 at a level far from the common level. In order to display white level on a normally white display panel, which has a transmission rate being the maximum when a driving potential is not applied thereto, by using the data signal of the positive polarity, the data driver outputs an electric potential V2 at a level near the common level is supplied.

The LCD apparatuses are requested to reduce the power consumption and increase the display speed. One solution is introduced by Japanese Laid-Open Patent Application No. Hei 11 (1999)-30975.

FIG. 12 is a circuit diagram showing the output circuit 10 of the conventional data driver described in the Application. The output circuit 10 has amplifiers 11₁-11₂ₙ connected to the voltage follower that output the driving voltage to data lines S1-S2n (n: integer). The output circuit 10 further has switches 12₁-12₂ₙ and 13₁-13₂ₙ₋₁ that separate the outputs of the amplifiers 11₁-11₂ₙ from the data lines S1-S2n, and short the lines between the adjacent data lines. The output circuit 10 drives the data line so that the adjacent data lines have opposite polarities based on the common level. The output circuit 10 further separates the outputs of the amplifiers 11₁-11₂ₙ from the data lines and shorts the lines between the adjacent data lines before the data signals are written. In this time, because the number of data lines that accumulate electric charges at levels higher than the common level and the number of data lines that accumulate electric charges at levels lower than the common level are equal halves, charge transfer occurs (depending on the state of the source level at that time) and the charges are canceled. Therefore, the level of the data line stabilizes at a level closer to the common level than the initial level of the data line.

However, if the levels of the accumulated charges on the data lines greatly differ between the positive and negative polarities, cancellation of the charges becomes insufficient, the electric potential of the data line stabilizes at a level further from the common level than a level when the level difference of the accumulated charges is small between the positive and negative polarities. As a result, for example, if a positive-polarity side level, which is far from the common level, stabilizes, for example, at electric potential V1 shown in FIG. 11, in the data line in which the data signal is written at a negative-polarity side level, which is next far from the common level, for example, electric potential V4 shown in FIG. 11, the circuit must decrease the electric potential to overcome the large difference in electric potentials (VΔ=V1−V4) using the amplifier, the decreasing time become longer. Therefore, this might increase delays in writing the data signal on the data line S1-S2n.

FIG. 13 is a circuit diagram showing the other output circuit 20 of the data driver shown in the document. For the same component as in FIG. 12, its explanation is abbreviated by using the same description of reference numerals. The difference between the output circuit 20 and the output circuit 10 is that the switches 13₁-13₂ₙ₋₁ in the output circuit 20 do not short the lines between all the data lines as in the output circuit 10, but are placed alternately for the data lines.

In the output circuit 20, when the outputs of the amplifiers 11₁-11₂ₙ are separated from the data lines before writing the data signals, and the lines are shorted between the data lines, the electric potential of the data line becomes a level closer to the common level than the initial level of the data line and stabilizes like the output circuit 10. However, even the output circuit 20 might also increase delays in writing the data signal on the data line like the output circuit 10.

A technique to solve the above-described problem in output circuits 10 and 20 is disclosed in Laid-Open Patent Application No. 2003-228353.

FIG. 14 is a circuit diagram showing the output circuit 30 of the data driver described in the Document 2003-228353. For the same component as in FIG. 12, its explanation is abbreviated by using the same description of reference numerals. The difference between the output circuit 30 and the output circuit 10 is that the output circuit 30 includes, in place of the switches 13₁-13₂ₙ₋₁, share lines CL1 and CL2, switches 33₁-33₂ₙ that connect/disconnect the data lines S1-S2n to the share lines CL1 and CL2, amplifiers 34₁ and 34₂ connected with a voltage follower that outputs the predetermined precharge voltage Vpc1 and Vpc2, and switches 35₁ and 35₂ that connect/disconnect the output from the amplifiers 34₁ and 34₂ to the share lines CL1 and CL2.

The share lines CL1 and CL2 are two lines. Among the data lines S1-S2n, the odd numbered data lines S1, S3, . . . , S2n−1 are connected to the share line CL1 in the share lines CL1 and CL2, and the even numbered data lines S2, S4, . . . , S2n are connected to the share line CL2 in the share lines CL1 and CL2

With the compositions described above, when driving the data lines, the data lines are driven so that the polarities of the adjacent data lines become opposite based on the common level. In addition, before writing the data signal, the outputs of the amplifiers 11₁-11₂ₙ are separated from the data lines and the odd numbered data lines S1, S3, . . . , S2n−1 are connected to the share line CL1 as well as the even numbered data lines S2, S4, . . . , S2n are connected to the share line CL2. And at this time, from the amplifiers 34₁ and 34₂, through the switches 35₁ and 35₂ and the share lines CL1 and CL2, precharge voltage Vpc1 is applied to the odd numbered data lines S1, S3, . . . , S2n−1 as well as Vpc2 is applied to the even numbered data lines S2, S4, . . . , S2n.

In the output circuit 30, if the outputs of the amplifiers 11₁-11₂ₙ are separated from the data lines before writing the data signal, and the precharge voltages Vpc1 and Vpc2 are applied through the share lines CL1 and CL2, since the data line is precharged not at the common level but at a predetermined electric potential with the same polarity as the polarity when writing the data signal on the data line next time, for example, at the intermediate electric potential in each polarity, the circuit need not decrease the electric potential to overcome the large difference in electric potentials using the amplifier, the decreasing time become shorter. As a result, slewing rate for writing the data signal from the data driver on the display panel can be further improved than the output circuits 10 and 20.

Meanwhile, the technique described in Patent Document No. 2003-228353 can decrease the delay of writing the data signal on the data line than the technique described in the Document No. Hei 11 (1999)-30975. However, Patent Document No. 2003-228353 is demanded to reduce the power consumption furthermore at the precharge.

### SUMMARY OF THE INVENTION

A driving method of the liquid crystal display (LCD) apparatus of the present invention uses a dot inversion driving method with which the data signals are written on the adjacent data lines of a display panel so that the polarities of the adjacent data lines become opposite based on a predetermined reference voltage. Before writing the data signals into the data lines, the data lines are separated from the data signals, and are shorted for a predetermined time. Then, a precharge voltage, with the same polarity as the polarity when writing the data signals on the data lines in a next sequence, is supplied.

In addition, a driving circuit of the LCD apparatus of the present invention use a dot inversion driving method with which data signals are written on the adjacent data lines of a display panel so that polarities of the adjacent data lines become opposite based on a predetermined reference voltage. The circuit includes amplifiers that output the data signals to the data lines, and first switch that separates the amplifiers from the data lines before writing the data signals. The circuit further includes a charge neutralizing and precharging device that shorts the data lines for a predetermined time and then supplies a precharge voltage with the same polarity as the polarity when writing the data signals on the data lines in a next sequence.

According to this invention, before writing data signals, charge levels on the data lines are neutralized between the adjacent data lines, and then precharge are started. This not only can improve the delay in writing data signals on the data lines, but also can reduce the power consumption at the same driving ability for increased load or enhance the driving ability at the load of the same power consumption.

### BRIEF DESCRIPTION OF THE DRAWINGS

The above and other aspects, advantages and features of the present invention will be more apparent from the following description of certain exemplary embodiments taken in conjunction with the accompanying drawings, in which:

FIG. 1 illustrates a block diagram showing the composition of a liquid crystal display apparatus related to the present invention

FIG. 2 illustrates a block diagram showing the composition of a data driver of the first embodiment of the present invention;

FIG. 3 illustrates a timing chart of each signal inputted in the data driver shown in FIG. 2;

FIG. 4 illustrates a graph describing the relationship between the number of levels of gray-output voltage characteristics and precharge voltage of the data driver shown in FIG. 2;

FIG. 5 illustrates a circuit diagram showing an example of the output circuit used for the data driver 120 shown in FIG. 2;

FIG. 6 illustrates a diagram describing the operation of the output circuit shown in FIG. 5;

FIG. 7 illustrates a circuit diagram showing another example of the output circuit used for the data driver shown in FIG. 2;

FIG. 8 illustrates a block diagram showing the composition of a data driver of the second embodiment of the present invention;

FIG. 9 illustrates a circuit diagram showing an example of the output circuit used for the data driver 130 shown in FIG. 8;

FIG. 10 illustrates a diagram describing the operation of the output circuit shown in FIG. 8;

FIG. 11 illustrates a graph showing the number of levels of gray-output voltage characteristics;

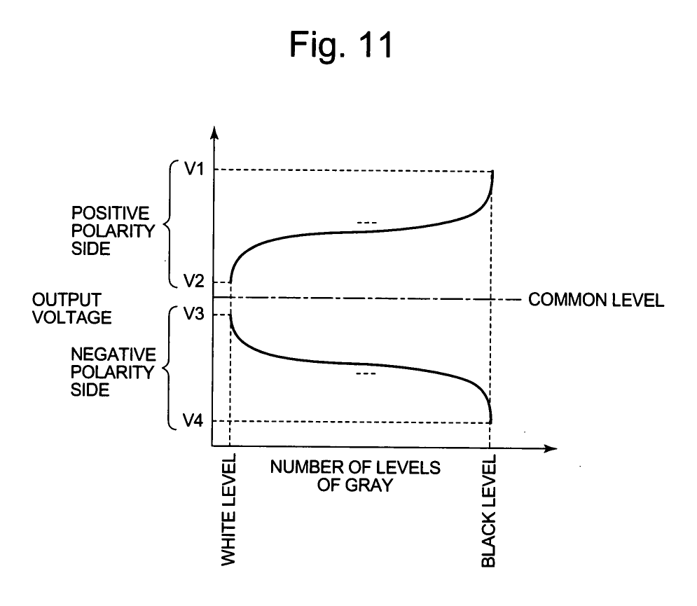

FIG. 12 illustrates a circuit diagram showing the output circuit of a data driver of a related art;

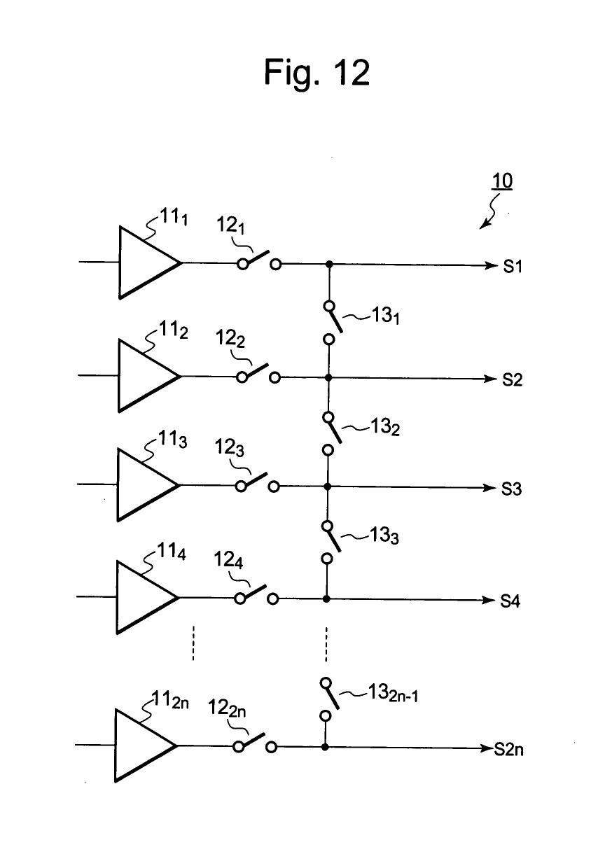

FIG. 13 illustrates a circuit diagram showing the output circuit of a data driver of a related art; and

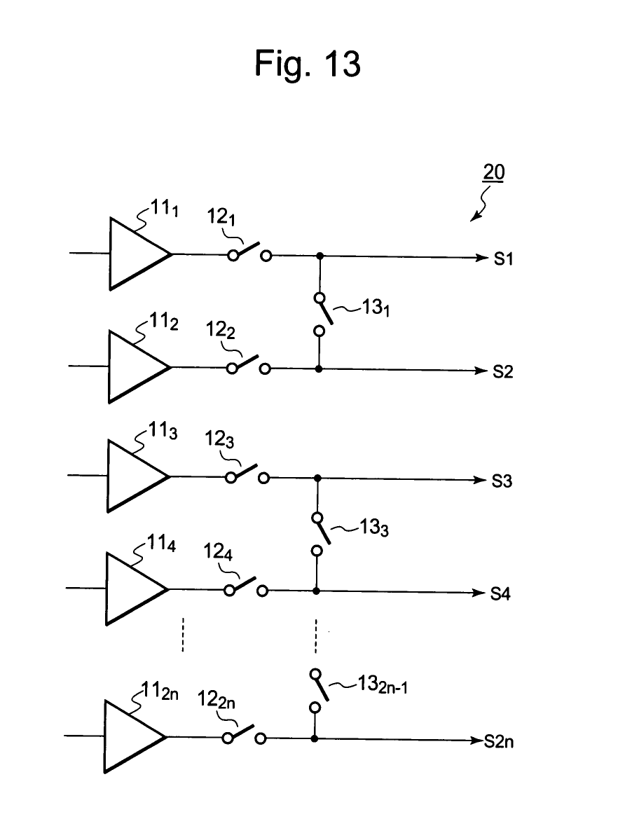

FIG. 14 illustrates a circuit diagram showing the output circuit of the data driver of the related art.

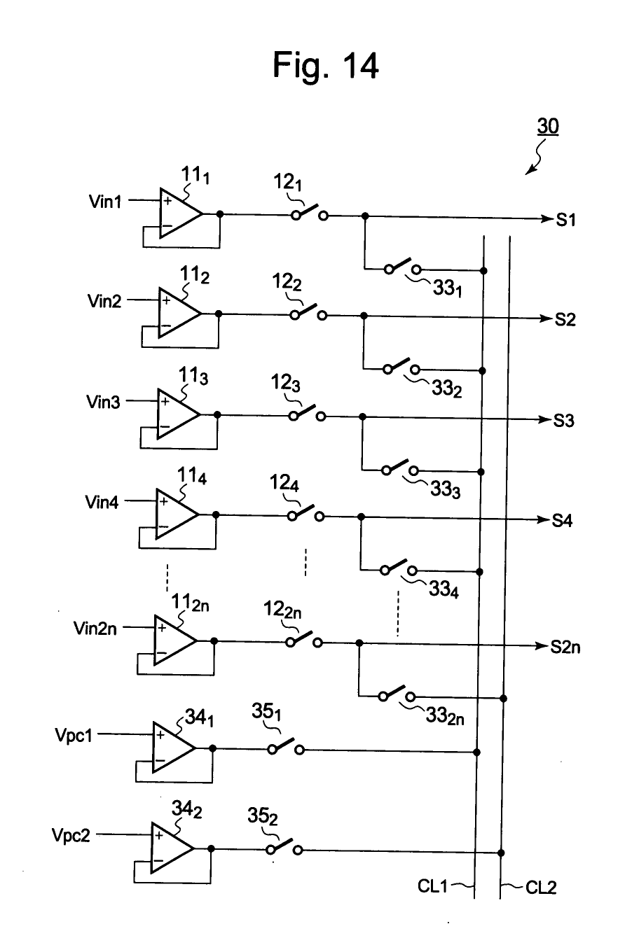

### DETAILED DESCRIPTION OF THE EXEMPLARY EMBODIMENT

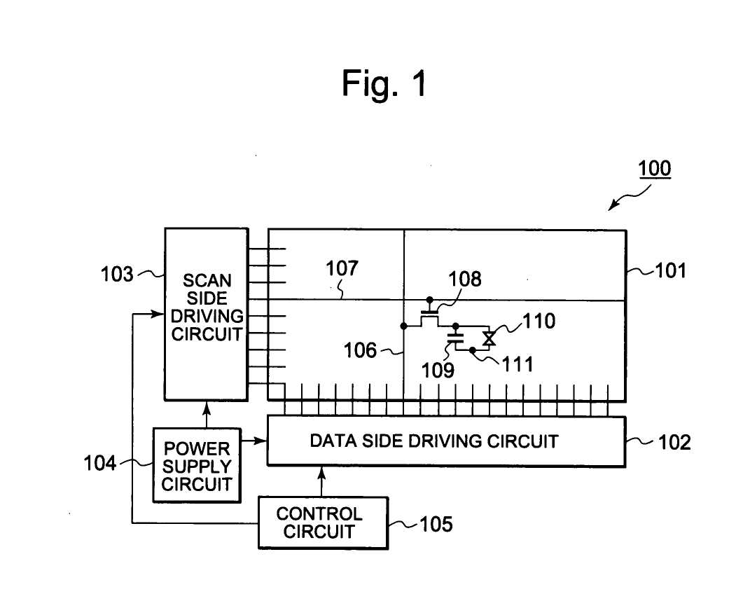

FIG. 1 is a schematic block diagram of a liquid crystal display related to the present invention. As shown in FIG. 1, a liquid crystal display 100 includes a liquid crystal display panel 101, a data driver 102, a scan side driving circuit 103, a power supply circuit 104 and a control circuit 105.

Meanwhile, for dot inversion driving, an example of 1 dot inversion driving, wherein the data signals are written so that the polarities become opposite between the odd-numbered data lines and the even-numbered data lines, is explained hereinafter; however, the present invention is also applicable to an n-dots reverse driving (n is 2 or more) system.

The liquid crystal display panel 101 includes a data line 106 that is stretched in vertical direction and a scan line 107 that is stretched in the horizontal direction. Each dot of R, G and B composed of each pixel is composed of a TFT 108, a pixel capacitor 109 and a liquid crystal element 110. The gate terminal and the source (drain) terminal of the TFT 108 are connected to the scan line 107 and the data line 106, respectively. The drain (source) terminals of the TFT 108 are connected to the pixel capacitor 109 and the liquid crystal element 110, respectively. A terminal 111 of the pixel capacitor 109 and the liquid crystal element 110 is connected to a common electrode, that is not shown in the drawing.

The data driver 102 outputs an analog signal voltage based on a digital image signal (hereinafter, referred to as “data”). The scan driver 103 outputs a selection/non-selection voltage of the TFT 108 to drive the scan line 107. The control circuit 105 controls the timing of driving by the scan driver 103 and the data driver 102. The power supply circuit 104 generates the signal voltage that the data driver 102 outputs and the selection/non-selection voltage that the scan driver 103 outputs to supply a voltage to each driving circuit.

The liquid crystal display apparatus 100 is driven by 1 dot inversion driving. Before driving the data line 106 by the analog signal voltage from the data driver 102, the data lines 106 are shorten for a predetermined time. Then, a precharge voltage is applied, with the same polarity as the polarity when driving, to the data line 106.

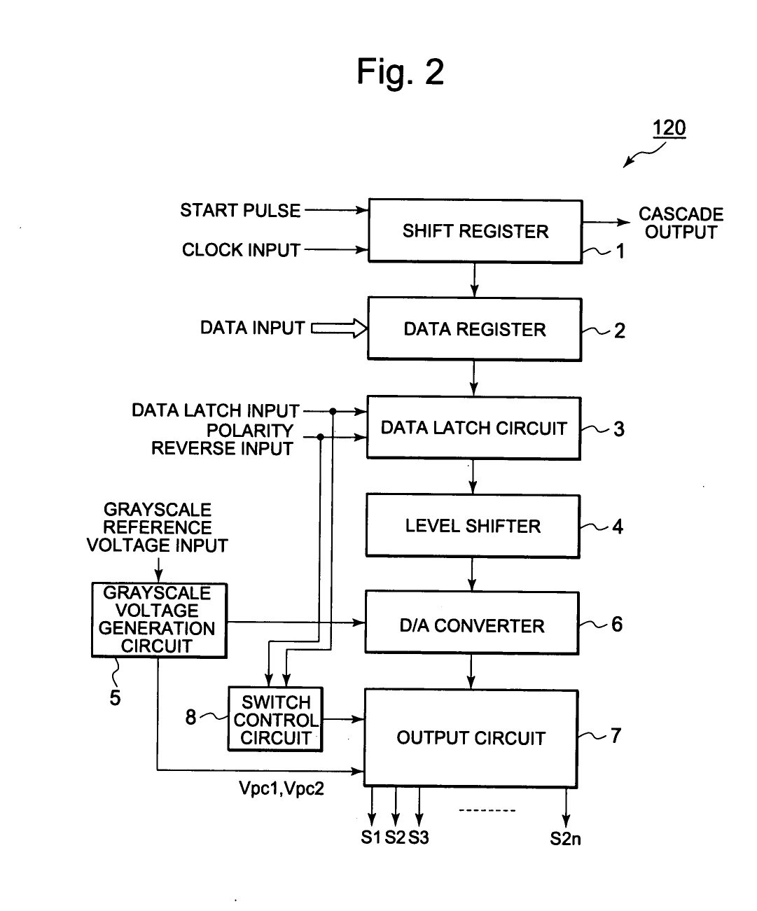

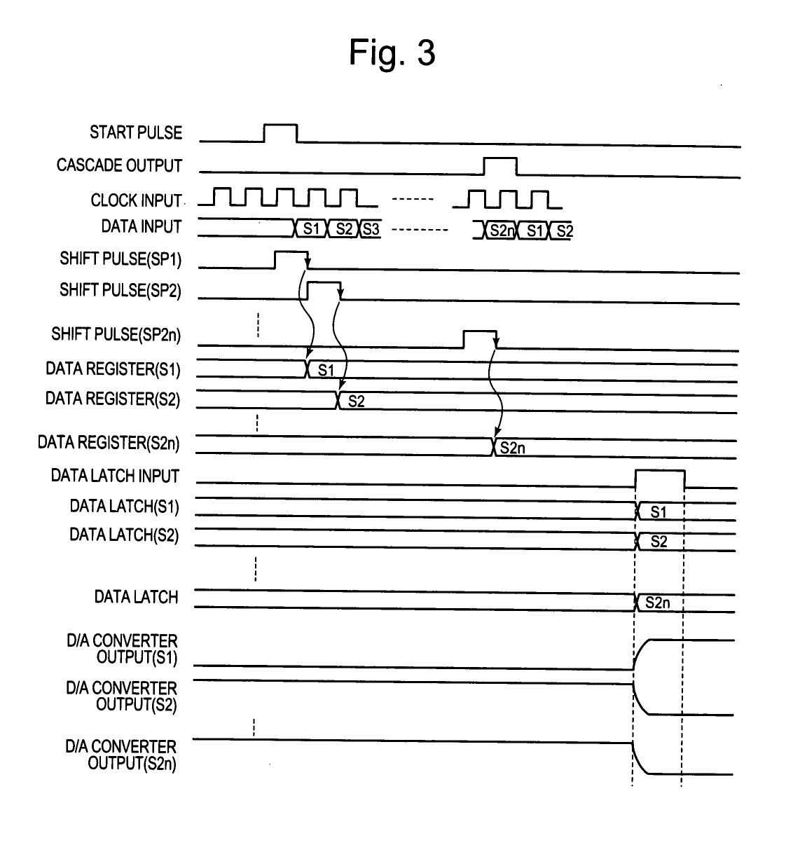

FIG. 2 is a schematic block diagram of a data driver 120 in the first example of embodiment for the present invention. FIG. 3 shows the timing chart of each signal, which is input in a data driver 120 shown in FIG. 2. The data driver 120 outputs analog signal voltage to 2n pieces=2m×dots data lines S1-S2n. In addition, to simplify the explanation, the data for the data driver 120 is explained to be acquired serially with a bit width of data corresponding to 1 piece of data lines S1-S2n, that is 1 dot of 1 pixel. The driver 120 includes a shift register 1, a data register 2, a data latch circuit 3, a level shifter 4, a grayscale voltage generation circuit 5, a D/A converter 6, an output circuit 7 and a switch control circuit 8. The outputs of the shift register of the data driver 120 are cascade-output to the next stage data drivers, and plural data drivers 120 are cascade-connected, which constitutes the data driver 102.

The shift register 1 includes 2n stage registers. When a start pulse and a clock are input in the shift resister, the start pulse is shifted sequentially by the timing of the clock to generate shift pulses (SP1)-(SP2n) as shown in FIG. 3.

The data register 2 contains 2n registers. When the data is input parallel in each resister, each register holds the data sequentially using the timing of, for example, the falling edge of the shift pulses (SP1)-(SP2n) that are supplied from the shift register.

After the data is input to all the registers of the data register 2, the data latch circuit 3 latches all the data stored in the registers of the data register 2 in response to the data latch signal and a polarity revise signal. The level shifter 4 shifts the levels of data latched by the data latch circuit 3.

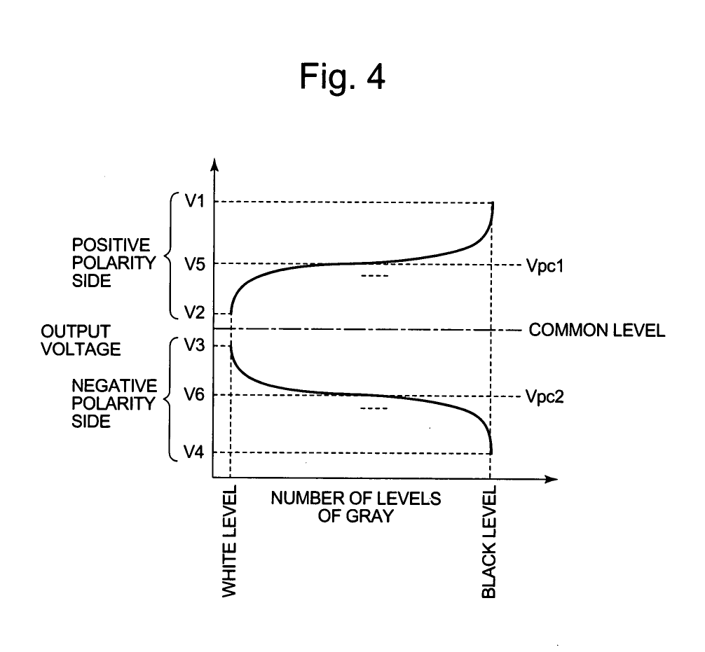

The grayscale voltage generation circuit 5 generates, for example, 256 grayscale positive polarity grayscale voltages and negative grayscale voltages in the case of 256 grayscale display based on a grayscale reference voltage. As shown in FIG. 4, each positive polarity grayscale voltage and negative grayscale voltage has the output characteristics of a curve according to the grayscale.

The D/A converter 6 decodes the data and selectively outputs the desired grayscaled positive polarity grayscale voltage and negative polarity grayscale voltage according to the data.

The output circuit 7 amplifies the output of the D/A converter 6 to output the analog signal voltage with a polarity according to the polarity reverse signal to the data lines S1-S2n, so that the polarities become opposite between the odd-numbered data lines and even-numbered data lines. Before the output circuit 7 outputs the analog signal voltage, under the state wherein the data lines S1-S2n are separated from the analog signal, the output circuit 7 shorts the data lines for a predetermined time. Then, the output circuit 7 supplies the precharge voltage. The precharge voltage has the same polarity as the polarity when the data lines S1-S2n is driven at the following sequence. The precharge voltage is desirable to be set to the most frequently selected grayscale level. For example, as shown in FIG. 4, the positive polarity precharge voltage. Vpc1 is set to the grayscale voltage electric potential V5, which is close to the intermediate electric potential (V1+V2)/2 of the electric potentials V1 and V2. The negative polarity precharge voltage Vpc2 is set to the grayscale voltage electric potential V6, which is close to the intermediate electric potential (V3+V4)/2 of the electric potentials V3 and V4. The precharge voltages Vpc1 and Vpc2 may use the voltages close to the intermediate electric potentials V5 and V6 among the grayscale reference voltages that are input in the grayscale voltage generation circuit 5. Also, the precharge voltages may use the voltages supplied from the external unit via an external pad.

The switch control circuit 8 receives the data latch signal and the polarity reverse signal and generates a control signal to perform the above-described operation of the output circuit 7.

Next, an example of embodiment of the output circuit 7 will be described in detail with reference to the accompanying drawings.

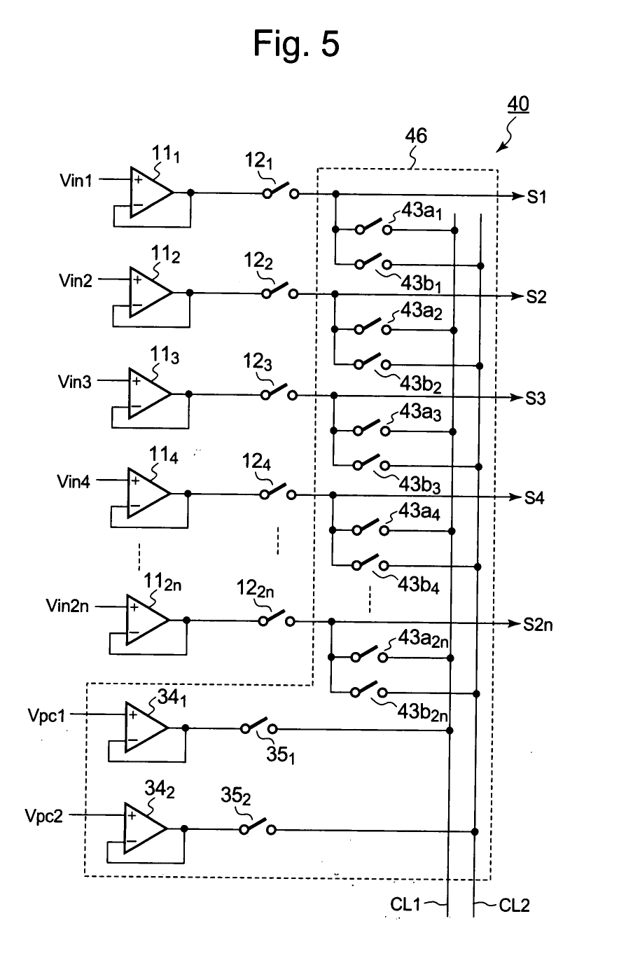

FIG. 5 is a circuit diagram showing an output circuit 40, which is an example of the output circuit 7 of FIG. 2. The output circuit 40 includes amplifiers 11₁-11₂ₙ, switches 12₁-12₂ₙ and a short/precharge circuit 46 that shorts the data lines S1-S2n for a predetermined time, and then supplies precharge voltages Vpc1 and Vpc2 to the data lines S1-S2n.

The short/precharge circuit 46 includes share lines CL1 and CL2, switches 43ₐ₁-43ₐ₂ₙ, 43_{b1}-43_{b2n}, 35₁ and 35₂, and amplifiers 34₁ and 34₂. The switches 43ₐ₁-43ₐ₂ₙ connect/disconnect the data lines S1-S2n to the share line CL1. The switches 43_{b1}-43_{b2n} connect/disconnect the data lines S1-S2n to the share line CL2. The control signal (not shown) from the switch control circuit 8 controls the switches 43ₐ₁-43ₐ₂ₙ, 43_{b1}-43_{b2n}, 35₁ and 35₂. The grayscale voltage generation circuit 5 supplies the precharge voltages Vpc1 and Vpc2 to the amplifiers 34₁ and 34₂, respectively.

The amplifiers 34₁ and 34₂ are enough with only a large driving ability, and high output accuracy is not required for the offset and the fluctuations in the rising waveform. At this time, the amplifiers 11₁-11₂ₙ requires high output accuracy for the offset and the fluctuations in the rising waveform, but amplifiers with a low driving ability can be used. Consequently, output circuit 40 can use a specialized circuit according to each characteristic of the amplifier.

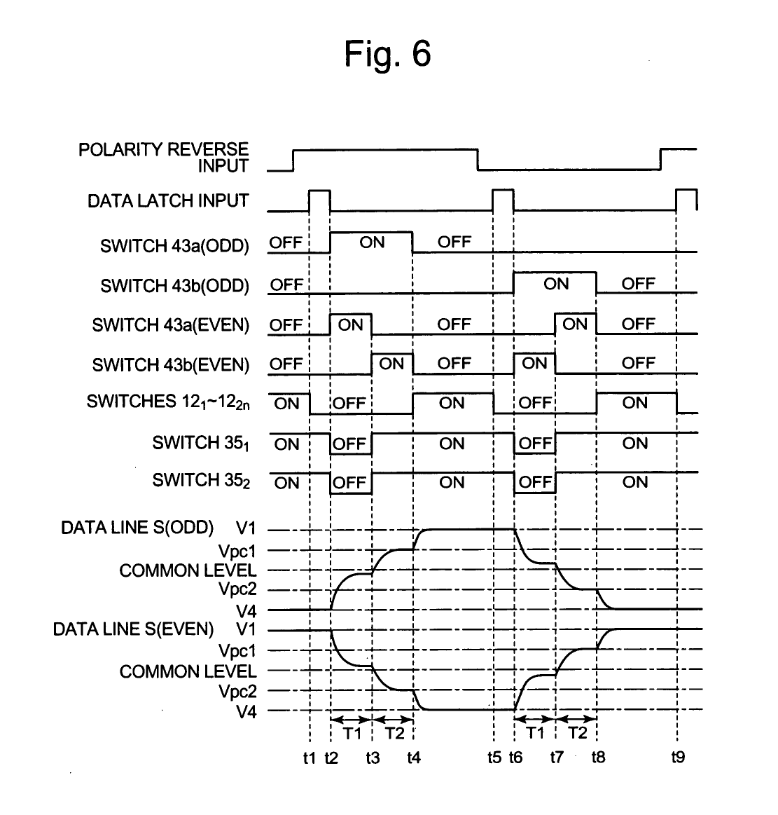

Operation of the output circuit 40 will be described with reference to FIG. 6.

Suppose that before the time t1, the odd-numbered data lines S1, S3, . . . , S2n−1 are driven by the negative polarity analog signal voltage at the electric potential V4, for example and the even-numbered data lines S2, S4, . . . , S2n are driven by the positive polarity analog signal voltage at the electric potential V1, as shown FIG. 4. At this time, the switches 12₁-12₂ₙ, 35₁ and 35₂ are on, and the switches 43ₐ₁-43ₐ₂ₙ and 43_{b1}-43_{b2n} are off.

At the time t1 when the data latch signal becomes “H (high)” level while the polarity reverse signal is “H” level, the switches 12₁-12₂ₙ are turned off, and the outputs of the amplifiers 11₁-11₂ₙ are separated from the data lines S1-S2n.

At the time t2 when the data latch signal becomes “L (low)” level, the switches 35₁ and 35₂ are turned off, the outputs of the amplifiers 34₁ and 34₂ are separated from the share lines CL1 and CL2, and the switches 43ₐ₁-43ₐ₂ₙ are turned on, and the data lines S1-S2n are connected to the share line CL1.

During a predetermined period T1 From the time t2 to the time t3, for example, 0.5 μs, each data line S1-S2n keeps shorted between the data lines. The number of the even-numbered data lines S2, S4, . . . , S2n that accumulate electric charges at levels higher than the common level, and the number of the odd-numbered data lines S1, S3, . . . , S2n−1 that accumulate electric charges at levels lower than the common level are equal halves. Therefore, charge transfer occurs and the charges are canceled, so that the levels of the data lines reach closer to the common level than the levels just before the time t2.

At the time t3, the switches 43ₐ₂, 43ₐ₄, . . . , 43ₐ₂ₙ are turned off and the even-numbered data lines S2, S4, . . . , S2n are separated from the share line CL1. The switches 43_{b2}, 43_{b4}, . . . , 43_{b2n} are turned on and the even-numbered data lines S2, S4, . . . , S2n are connected to the share line CL2. At that time, the switches 35₁ and 35₂ are turned on and the outputs of the amplifiers 34₁ and 34₂ are connected to the share lines CL1 and CL2. During a predetermined period T2 from the time t3 to the time t4, for example, 0.5 μs, the precharge voltage Vpc1 is applied to the odd-numbered data lines S1, S3, . . . , S2n−1 through the common line CL1, so that the level of these lines reach the positive polarity electric potential V5, which is near the intermediate electric potential of the electric potentials V1 and V2 shown in FIG. 4. The precharge voltage Vpc2 is applied to the even-numbered data lines S2, S4, . . . , S2n through the common line CL2, so that the level of these lines reach the positive polarity electric potential V6, which is near the intermediate electric potential of the electric potentials V3 and V4 shown in FIG. 4.

At the time t4, the switches 43ₐ₂, 43ₐ₂, 43ₐ₂ₙ₋₁, 43_{b2}, 43_{b2}, . . . , 43_{b2n} are turned off and the data lines S1-S2n are separated from the share line CL1 and CL2. The switches 12₁-12₂ₙ are turned on and the outputs of the amplifiers 11₁-11₂ₙ are connected to the data lines S1-S2n.

During the period from the time t4 to the time t5 until the polarity reverse signal becomes “L” and the data latch signal becomes “H”, the odd-numbered data lines S1, S3, . . . , S2n−1 are driven according to the data, for example, with the positive polarity grayscale voltage at an electric potential V1 shown in FIG. 4, and the even-numbered data lines S2, S4, . . . , S2n are driven according to the data, for example, with the negative polarity grayscale voltage at an electric potential V4 shown in FIG. 4

At the time t5, just the same as at the time t1, the switches 12₁-12₂ₙ are turned off, and the outputs of the amplifiers 11₁-11₂ₙ are separated from the data lines S1-S2n.

At the time t6 when the data latch signal becomes “L” level, the switches 35₁ and 35₂ are turned off and the output of the amplifiers 34₁ and 34₂ are separated from the share lines CL1 and CL2, and the switches 43_{b1}-43_{b2n} are turned on and the data lines S1-S2n are connected to the share line CL2.

From the time t6 to the time t7, just as in the period from the time t1 to t2, the level of each data line S1-S2n becomes closer to the common level than the level of the data line just before t6.

At the time t7, the even-numbered switches 43_{b2}, 43_{b4}, . . . , 43_{b2n} are turned off and the even-numbered data lines S2, S4, . . . , S2n are separated from the share line CL2. The even-numbered switches 43ₐ₂, 43ₐ₂, . . . , 43ₐ₂ₙ are turned on and the even-numbered data lines S2, S4, . . . , S2n are connected to the share line CL1. At that time, the switches 35₁ and 35₂ are turned on and the outputs of the amplifiers 34₁ and 34₂ are connected to the share lines CL1 and CL2. During a predetermined period T2 from the time t7 to the time t8, the precharge voltage Vpc2 is applied to the odd-numbered data lines S1, S3, . . . , S2n−1 through the common line CL2 reaching the electric potential V6 with a polarity that is close to the intermediate electric potential of the electric potentials V3 and V4 shown in FIG. 4. Also, the precharge voltage Vpc1 is applied to the even-numbered data lines S2, S4, . . . , S2n through the common line CL1, reaching the positive polarity electric potential V5 that is close to the intermediate electric potential of the electric potentials V1 and V2 shown in FIG. 4.

At the time t8, the switches 43ₐ₂, 43ₐ₄, 43ₐ₂ₙ, 43_{b1}, 43_{b3}, . . . , 43_{b2n-1} are turned off and the data lines S1-S2n are separated from the share lines CL1 and CL2. The switches 12₁-12₂ₙ are turned on and the outputs of the amplifiers 11₁-11₂ₙ are connected to the data lines S1-S2n.

From the time t8 to the time t9 until the polarity reverse signal becomes “H” and the data latch signal becomes “H”, the odd-numbered data lines S1, S3, . . . , S2n−1 are driven according to the data, for example, with the negative polarity grayscale voltage at an electric potential V4 shown in FIG. 4, and the even-numbered data lines S2, S4, . . . , S2n are driven according to the data, for example, with the positive polarity grayscale voltage at an electric potential V1 shown in FIG. 4. Hereinafter, operations from the time t1 to the time t9 are repeated.

By the above, when a data line, which was driven with the positive polarity analog signal voltage, is driven in the next time with analog signal voltage at a negative polarity level that is far from the common level, for example, at the electric potential V4 shown in FIG. 4, the data lines are shorted once between them for a predetermined time to make the levels of the data line close to the common line. Then, the data line is precharged using the precharge voltage Vpc2 that is set to the intermediate electric potential V6 of the negative polarity grayscale voltage. Therefore, the precharge can be started from a level close to the common level. Accordingly, this embodiment can decrease the delay in writing the data signal on the data line and reduce the power consumption for precharging, compared with the document No. 2003-228353. Alternatively, if the power consumption of the data driver is the same, enhancing the driving ability under load is possible.

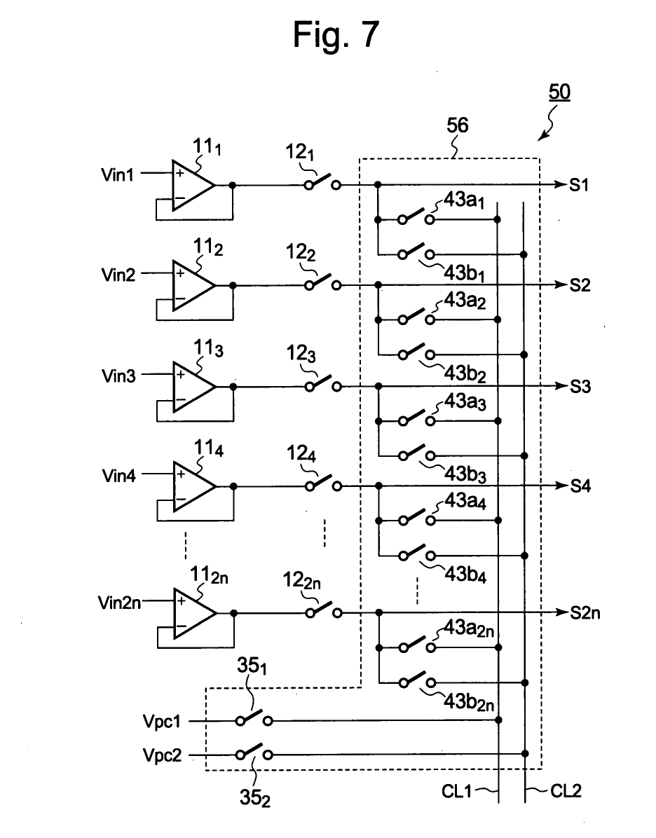

It is noted that, as shown in an output circuit of FIG. 7, it is also possible to supply the precharge voltages Vpc1 and Vpc2 without using the amplifiers 34₁ and 34₂.

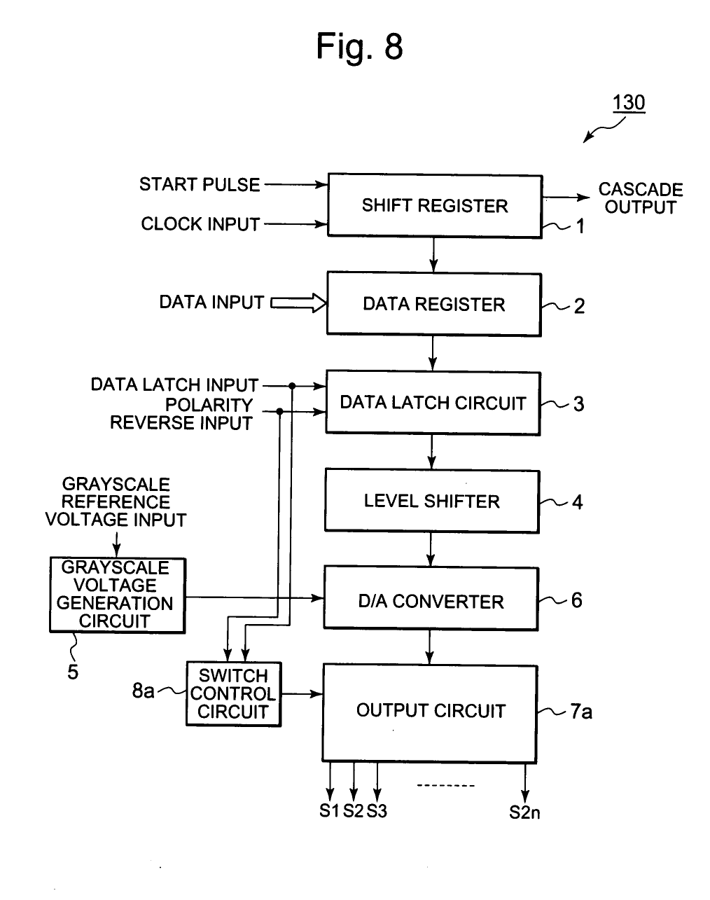

FIG. 8 is a block diagram showing a data driver 130 according to a second embodiment for the present invention.

The timing chart of each signal input in the data driver 130 can be used shown in FIG. 3. The data driver 130 includes a shift register 1, a data register 2, a data latch circuit 3, a level shifter 4, a grayscale voltage generation circuit 5, a D/A converter 6, an output circuit 7a, and a switch control circuit 8a.

The output circuit 7a amplifies the output of the D/A converter 6, and outputs the analog signal voltage with a polarity according to the polarity reverse signal to data lines S1-S2n. In case that the data lines S1-S2n are not driven by the analog signal voltage, the data lines between the same polarities for a first predetermined time are shorten to recover charge using the capacitor, and shorts the data lines between the opposite polarities for a second predetermined time are shorten. Then a precharge voltage is supplied with the data lines. The precharge voltage has the same polarity as the polarity when the data lines S1-S2n are driven in next sequence. The charge recovered to the capacitor is used as the precharge voltage. The precharge voltage from the capacitor makes the positive charge precharge voltage Vpc1 nearly equal to the level of the intermediate electric potential (V1+V2)/2 of the electric potentials V1 and V2, and the negative charge precharge voltage Vpc2 nearly equal to the level of the intermediate electric potential (V3+V4)/2 of the electric potentials V3 and V4.

When the data latch signal and the polarity reverse signal are input in the switch control circuit 8a, it generates the control signal to perform the operation of the output circuit 7a described above.

Next, an example of embodiment of the output circuit 7a will be described in detail with reference to the accompanying drawings.

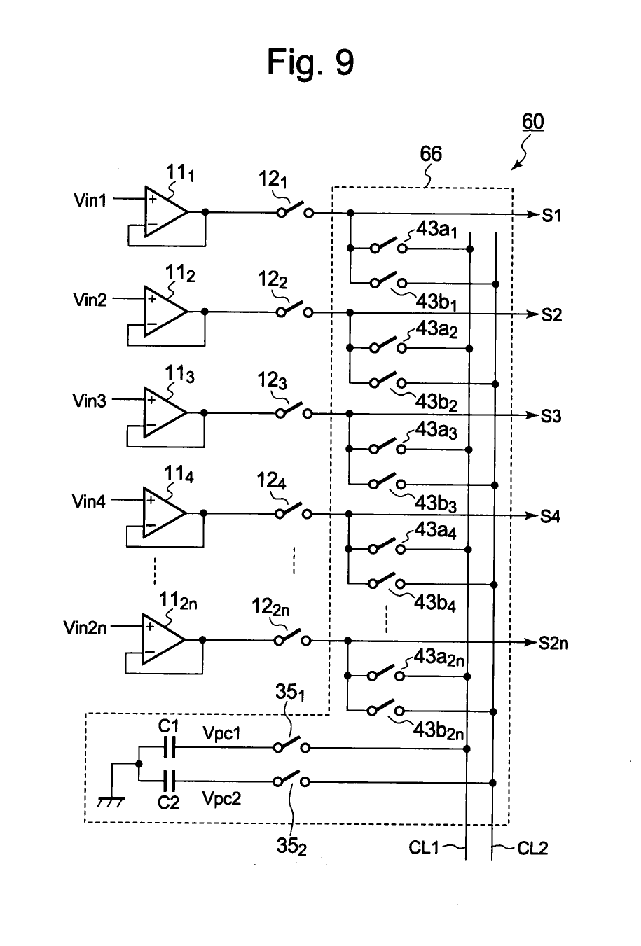

FIG. 9 is a circuit diagram showing the output circuit 60 of an example used as the output circuit 7a. The difference between the output circuit 60 and the output circuit 40 is that the circuit 60 includes a short/precharge circuit 66 in place of a short/precharge circuit 46. In the circuit 66, capacitors C1, C2 for recovering charges are connected between switches 35₁ and 35₂ and the ground, respectively in place of the amplifiers 34₁ and 34₂. The capacitors C1 and C2 can be attached to the inside of a semiconductor integrated circuit device, or they can be external capacitors.

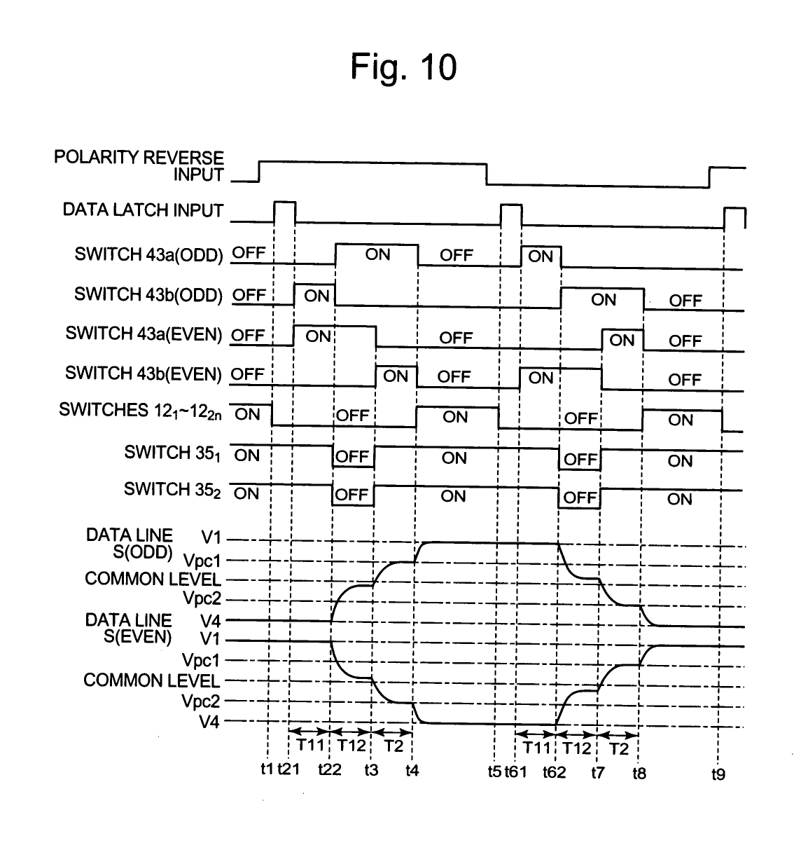

Operation of the output circuit 60 will be described with reference to FIG. 10. Operation differed from FIG. 6 is that it occurs in periods from the times t21 and t61 to the times t22 and t62 until the predetermined period T11 has elapsed, respectively, and periods from the times t22 and t62 to the times t3 and t7 until the predetermined period T12 has elapsed, respectively. Hereinafter, operation in these periods will be described.

At the time t21 when the data latch signal becomes “L” level, the switches 43ₐ₂, 43ₐ₄, . . . , 43ₐ₂ₙ are turned on and the even-numbered data lines S2, S4, . . . , S2n are connected to the share line CL1. The switches 43_{b2}, 43_{b4}, . . . , 43_{b2n} are turned on and the even-numbered data lines S2, S4, . . . , S2n are connected to the share line CL2. During a predetermined period T11 from the time t21 to the time t22, for example, 0.5 μs, charge transfer occurs from the even-numbered data lines S2, S4, . . . , S2n that accumulate charges at levels higher than the common level to the capacitor C1 through the share line CL1, recovering charge according to the capacity of the capacitor C1. Charge transfer occurs from the odd-numbered data lines S1, S3, . . . , S2n−1 that accumulate charges at levels lower than the common level to the capacitor C2 through the share line CL2, recovering charge according to the capacity of the capacitor C2.

At the time t22, the switches 35₁ and 35₂ are turned off and the outputs of the amplifiers 34₁ and 34₂ are separated from the share lines CL1 and CL2. The switches 43_{b1}, 43_{b3}, . . . , 43_{b2n-1} are turned off as well as the switches 43ₐ₁, 43ₐ₃, . . . , 43ₐ₂ₙ₋₁ are turned on. Therefore, the odd-numbered data lines S1, S3, . . . , S2n−1 are separated from the share line CL2 and connected to CL1.

During a predetermined period T12 from the time t22 to the time t3, for example, 0.5 μs, just as the period from the time t2 to t3 in FIG. 6, the level of each data line S1-S2n becomes closer to the common level than the level of the data line just before t22.

At the time t61 when the data latch signal becomes “L” level, the switches 43ₐ₁, 43ₐ₃, . . . , 43ₐ₂ₙ₋₁ are turned on and the odd-numbered data lines S1, S3, . . . , S2n−1 are connected to the share line CL1, and the switches 43_{b2}, 43_{b4}, . . . , 43_{b2n} are turned on and the even-numbered data lines S2, S4, . . . , S2n are connected to the share line CL2.

During a predetermined period T11 from the time t61 to the time t62, charge transfer occurs from the odd-numbered data lines S1, S3, . . . , S2n−1 that accumulate charges at levels higher than the common level to the capacitor C1 through the share line CL1, recovering charge according to the capacity of the capacitor C1. Also, charge transfer occurs from the even-numbered data lines S2, S4, . . . , S2n that accumulate charges at levels lower than the common level to the capacitor C2 through the share line CL2, recovering charge according to the capacity of the capacitor C2.

At the time t62, the switches 35₁ and 35₂ are turned off and the outputs of the amplifiers 34₁ and 34₂ are separated from the share lines CL1 and CL2. The switches 43ₐ₁, 43ₐ₃, . . . , 43ₐ₂ₙ₋₁ are turned off as well as the switches 43_{b1}, 43_{b3}, . . . , 43_{b2n-1} are turned on. Therefore, the odd-numbered data lines S1, S3, . . . , S2n−1 are separated from the share line CL1 and connected to CL2.

During a predetermined period T12 from the time t62 to the time t7, just as the period from the time t22 to t3, the level of each data line S1-S2n becomes closer to the common level than the level of the data line just before t62.

By the above, for example, when a data line, which was driven with the positive polarity analog signal voltage, is driven in the next time with analog signal voltage at a negative polarity level that is far from the common level, for example, at the electric potential V4 shown in FIG. 4, before driving, with the data line separated from the analog signal voltage, the data lines are shorted between the positive polarity data lines for the first prescribed time to recover charge using a capacitor, and the data lines are shorted between the opposite polarity data lines for the second prescribed time to make the levels of the data lines close to the common level. Then, the charge, which is recovered in the capacitor with the same polarity as the polarity when driving the data lines, is supplied to the circuit as a precharge voltage. For this reason, without supplying the precharge voltage from the device other than this output circuit, the precharge can be started from a level close to the common level, improving the delay in writing the data signal on the data line and enabling further to reduce the power consumption for precharging than the technique disclosed in the Document No. 2003-228353. Alternatively, if the power consumption of the data driver is the same, enhancing the driving ability under load is possible.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A driving method of a liquid crystal display apparatus, comprising:
with a dot inversion driving method, writing a data signal on adjacent data lines of a display panel, so that polarities of said data lines become reverse on a basis of a predetermined reference voltage;
before said data signal is written,
shorting said data lines; and
supplying a precharge voltage having a same polarity as a polarity when the data signal is written on said adjacent data lines.

2. The driving method of the liquid crystal display apparatus according to claim 1, wherein said data lines are shorted between opposite polarities.

3. The driving method of the liquid crystal display apparatus according to claim 2, wherein said data lines are supplied with said precharge voltage for the same polarity through a share line.

4. The driving method of the liquid crystal display apparatus according to claim 3, wherein said precharge voltage is a voltage of substantially an intermediate level of a grayscale voltage for each polarity.

5. The driving method of the liquid crystal display apparatus according to claim 3, wherein said share line comprises two lines.

6. The driving method of the liquid crystal display apparatus according to claim 5, wherein either one of said two share lines is used as a line to short said data lines.

7. The driving method of the liquid crystal display apparatus according to claim 3, wherein said precharge voltage is supplied to said share lines through an amplifier.

8. The driving method of the liquid crystal display apparatus according to claim 1,
wherein said data lines are shorted during said predetermined time comprising a first predetermined time and a second predetermined time,
wherein said data lines are shorted for the same polarity and a charge is recovered by a capacitor in the first predetermined time, and said data lines are shorted for opposite polarities in the second predetermined time, and
wherein the recovered charge is used as said precharge voltage.

9. The driving method of the liquid crystal display apparatus according to claim 8, wherein said data lines are supplied with said charge recovered by said capacitor through a share line for the same polarity.

10. The driving method of the liquid crystal display apparatus according to claim 9, wherein said share line is composed of two lines.

11. The driving method of the liquid crystal display apparatus according to claim 10, wherein either one of said two share lines is used as a line to short said data lines for said second predetermined time.

12. A data driver of a liquid crystal display apparatus, comprising:
a plurality of nodes each to connect a corresponding one of a plurality of data lines on a display panel;
a plurality of amplifiers, each of which outputs a data signal to a corresponding one of said nodes in a dot inversion driving manner with which a data is written on adjacent data lines so that polarities become reverse on a basis of the predetermined reference voltage;
a switch that separates said amplifiers from said nodes before transferring said data signal to said nodes; and
a short precharge circuit, when said amplifiers are separated from said nodes, that shorts said nodes for a predetermined time and then supplies said nodes with a precharge voltage having a same polarity as a polarity during said transferring.

13. The data driver according to claim 12, wherein said short precharge circuit includes:
two share lines to which a precharge voltage is supplied so that the polarities become opposite on the basis of said predetermined reference voltage;
a second switch that connects said node to one of said share lines;
a third switch that connects said node to the other of said share lines;
a fourth switch that enables one polarity side of said precharge voltage to connect to said one of said share lines; and
a fifth switch that enables the other polarity side of said precharge voltage to connect to the other of said share lines.

14. The data driver according to claim 13, wherein said data driver controls to turn on either one of said second and third switches, and then to turn on said fourth and fifth switches as well as to turn on the second and third switches to supply the precharge voltage with the same polarity as the polarity during said transferring.

15. The data driver according to claim 14, wherein said precharge voltage is supplied to said share lines through an amplifier connected to a voltage follower.

16. The data driver according to claim 13,
wherein said predetermined time comprises a first predetermined time and a second predetermined time,
wherein said share lines are connected to a capacitor through said fourth and fifth switches,
wherein, in said first predetermined time, said fourth and fifth switches are controlled to turn on as well as said second and third switches are controlled to turn on, to recover the charge from said data lines to said capacitor for the same polarity;
wherein, in the second predetermined time, said fourth and fifth switches are controlled to turn off as well as either one of said second and third switches is controlled to turn off, and
wherein said fourth and fifth switches are controlled to turn on as well as said second and third switches are controlled to turn on, to supply the recovered charge in said capacitor with the same polarity as the polarity when writing the data signals on said data lines.

17. A data driver, comprising:
a plurality of nodes each provided to connect to a corresponding one of a plurality of data lines on a display panel;
a first line supplied with a first voltage;
a second line supplied with a second voltage;
a plurality of first switches respectively provided between each of said nodes and said first line; and
a plurality of second switches respectively provided between each of said nodes and said second line.

18. The data driver as claimed in claim 17, further comprising:
a third switch coupled to said first line; and
a fourth switch coupled to said second line.

19. The data driver as claimed in claim 18, further comprising:
a first precharge circuit coupled to said third switch; and
a second precharge circuit coupled to said fourth switch.

20. The data driver as claimed in claim 18, further comprising:
a first capacitor coupled to said third switch; and
a second capacitor coupled to said fourth switch.

21. A driver of a liquid crystal display apparatus, comprising:
means for writing a data signal on adjacent data lines of a display panel so that polarities of said data lines become reverse on a basis of a predetermined reference voltage;
means, before said data signal is written, for shorting said data lines; and
means for supplying a precharge voltage having a same polarity as a polarity when the data signal is written on said adjacent data lines.
